(19) United States
(12) Patent Application Publication
(10) Pub. No.: US 2011/0043337 A1
(43) Pub. Date: Feb. 24, 2011

(54) DEVICE AND SYSTEM FOR DETECTING THE PASSAGE OF OBJECTS, PERSONS OR ANIMALS WITH AN RFID TAG ACCORDING TO THEIR PASSING ORDER, AND APPLICATION IN LUGGAGE DETECTION

(75) Inventor: Philippe Pierre, Dugny (FR)

Correspondence Address: GREER, BURNS & CRAIN, 300 S WACKER DR, 25TH FLOOR, CHICAGO, IL, 60606, US

(73) Assignee: IER, Suresnes (FR)

(21) Appl. No.: 12/922,502

(22) PCT Filed: Mar. 5, 2009
(86) PCT No.: PCT/FR2009/050366

§ 371 Date: Sep. 14, 2010

(30) Foreign Application Priority Data
Mar. 14, 2008 (FR) 0851677

(51) Int. Cl. H04Q 5/22

(52) U.S. Cl. 340/10.1

(57) ABSTRACT

A device for the detection of the passage of objects, persons or animals bearing a so-called RFID tag, the device including at least one first movable support bearing an antenna electrically connected to a tag reader and at least one second movable support, each of the movable supports forming, when idle, a barrier with respect to the passage of the objects, persons or animals, and which, on contact with these latter, is movable to a retracted position, the second movable support being arranged upstream of the first movable support with respect to the direction of passage of the objects, persons or animals and being made of a material attenuating the passage of the electromagnetic waves in the direction opposite to that of the passage of the objects, persons or animals.

The present invention relates to a device for the detection of the passage of objects, persons or animals bearing a radio frequency identification (RFID) tag.

The invention also relates to the application of the device according to the invention to the identification of objects fitted with RFID tags, transported on a conveyor.

In a preferred application of the invention, the aforementioned objects are baggage items conveyed towards a portal or tunnel.

Currently, portals or tunnels are fitted with fixed and rigid antennas, connected to an RFID reader which allows the tags fixed or bonded on the baggage items to be read remotely, thus allowing the latter to be identified.

However, the reading of the tags by the antennas poses several problems:
the distance between the antennas and the RFID tag
the orientation of the plane of the antenna with respect to the plane of the tag.

If this distance or orientation is not optimum, the object, i.e. the baggage item, is in danger of not being read and failing to be identified.

Moreover, mutual interference between several RFID reading or writing devices can also affect the reliable functioning of the system.

In French Patent Application No. 07 02111 filed on 23 Mar. 2007 by the Applicant, to date unpublished, a device for the detection of passage is described, proposing a solution to the aforementioned problems.

However, when several objects, persons or animals follow each other, the device described in Application No. 07 02111 does not make it possible to distinguish the order in which the objects, persons or animals pass. In fact, tags using UHF are environmentally sensitive. They are designed to operate with a known dielectric: the paper or plastic support strip. They must operate without any contact with other materials. Within the context of baggage monitoring, if the tag is pressed against the conveyor by the baggage item, this will alter the tuning frequency of the antenna of the tag, and as a result, the RFID reader will receive a frequency-shifted signal that has a lower amplitude level. Thus, when a first object, the tag of which is confined against the conveyor, is followed closely by a second object, the tag of which is exposed to the atmosphere in the normal manner, the shift in the tuning frequency can cause detection of the second object before the first. This situation becomes more complex when there is a large number of objects and these objects follow each other closely.

The purpose of the present invention is to overcome the above drawbacks.

A further purpose of the invention is to propose a device and a system making it possible to carry out the detection of objects, persons or animals in an ordered manner with respect to the order in which they pass.

This purpose is achieved, according to the invention, using a device for the detection of the passage of objects, persons or animals bearing a so-called RFID (Radio Frequency IDentification) tag, said device comprising at least one first movable support bearing an antenna electrically connected to a tag reader and at least one second movable support, each of said movable supports forming, when idle, a barrier or curtain with respect to the passage of said objects, persons or animals, and which, on contact with these latter, is capable of moving to a retracted position, said second movable support being arranged upstream of said first movable support with respect to the direction of passage of said objects, persons or animals and being made of a material attenuating the passage of the electromagnetic waves in the direction opposite to that of the passage of the objects, persons or animals.

Thus, when a first and a second object or others follow each other, the second object, located further from the first support bearing the detection antenna in relation to the first object, is at least partially isolated from the electromagnetic waves by the second movable support which attenuates the passage of the electromagnetic waves towards this second object. As the electromagnetic waves are attenuated at the level of the second object, the first object is detected before the second object despite the possible sensitivity difference between the radio frequency identification tags borne by the first object and the second object.

The reading conditions of the tags of the objects are thus significantly improved in comparison with the known devices and an ordered reading of the objects during their passage is made possible by the device according to the invention.

In the rest of the present description, the term object (or objects) will be used to denote the objects, persons or animals, in order to avoid overloading the text of the present description.

According to a version of the device of the invention, at least a third movable support forming, when idle, a barrier or curtain with respect to the passage of the objects and which, on contact with the latter, is capable of moving to a retracted position, is arranged upstream of the second movable support and attenuates the passage of the electromagnetic waves in the direction opposite to that of the passage of the objects. Thus, there is greater attenuation of the electromagnetic waves passing towards the objects following the object of which the tag is read.

According to another version of the device according to the invention that can be combined with the other above-described versions of the device, at least a fourth movable support forming, when idle, a barrier or curtain with respect to the passage of the objects, and which, on contact with the latter, is capable of moving to a retracted position, is arranged downstream of the first movable support, attenuating the passage of the electromagnetic waves. Thus, the passage of the electromagnetic waves is attenuated towards the objects which have already been detected.

Advantageously, in a particular version, the different movable supports are spaced apart in the direction of movement of the objects, by a distance that is equal, plus or minus 15%, to the wavelength of the electromagnetic waves used for the detection. In an application where the waves used are electromagnetic waves having a frequency situated between 865.6 and 867.6 MHz the wavelength, is approximately thirty cm. The distance between the supports is therefore in this case approximately 34 cm, for example comprised between 29 and 39 cm.

In a preferred version of the device according to the invention, the different movable supports are spaced apart in the direction of movement of the objects by a distance comprised between 2.5 and 3 times the wavelength of the electromagnetic waves used for the detection.

In an embodiment of the invention, at least one of the movable supports is rigid and is articulated about an axis situated above the passage zone.

In another embodiment of the invention, at least one of the movable supports is rigid and is articulated about a transverse axis arranged vertically at the side of the passage zone.

In these examples, where at least one movable support is rigid, the latter pivots when struck by an object.

In a further embodiment of the invention, at least one of the movable supports is flexible and is articulated about an axis arranged vertically at the side of the passage zone.

In a preferred version of the invention, at least one of the movable supports is made of a flexible material and is suspended freely about a transverse axis situated above the passage zone.

Thus, the movable support bends when it is struck by an object, while remaining in contact with the object until the latter, continuing its movement, clears the movable support completely. Excellent conditions for reading the tag borne by the objects are thus obtained.

Preferably, the antenna is located close to the lower end of the movable support so as to be in the passage zone.

More particularly, the antenna can preferably be situated approximately at a height of 25 cm with respect to the plane of a conveyer on which the objects are located.

Thus, the antenna is situated close to the objects to be identified, which allows optimum reading conditions to be obtained.

When the device according to the invention is used for the detection of animals, the antenna can be situated approximately at the height of the neck of the animals.

When the device according to the invention is used for the detection of persons, the antenna can be situated approximately at the height of the sternum of the persons.

In an advantageous version of the invention, at least one of the movable supports comprises several flexible strips, positioned side by side in a plane transverse to the direction of passage of said objects, persons or animals.

In this advantageous version, the first and the second supports comprise several flexible strips, positioned, side by side, in a plane transverse to the direction of the passage of the objects, persons or animals. At least one of the strips of the first support bears an antenna on its lower part.

In an embodiment of the device according to this advantageous version, all the strips of the first support each bear a detection antenna.

Because of these juxtaposed flexible strips, it is possible to read several objects passing simultaneously through the flexible curtain constituted by the strips or objects situated at any point in the width of passage.

This arrangement makes it possible to avoid any risk that an object is not identified or that the objects are damaged during detection.

Preferably, the flexible strips extend over substantially the whole width of passage and the lower end of the flexible strips is located close to the base of said passage.

Advantageously, the antenna is located on the face of the strip or support opposite to that coming into contact with the objects. In this way any risk of friction between the object and the antenna, which could damage the latter, is avoided.

According to an advantageous version of the device according to the invention, the antenna is arranged approximately vertically with respect to the plane of passage of the objects, persons or animals. In fact, tests have shown that an approximately vertical arrangement of the antenna with respect to the plane of passage of the objects gives a better detection of the objects during their passage.

According to an advantageous embodiment of the device according to the invention, the first, support and/or the strips of the first support bearing at least one antenna are made of a non-conductive material, on which are fixed the antenna and its connection circuit to the tag reader, the antenna being arranged on the face of the first support, and/or strips of the first support, opposite to the face coming into contact with the objects, persons or animals.

According to another embodiment, the first support and/or the strips of the device according to the invention can be made of any flexible material, such as synthetic material, rubber or non conductive textile. The antenna and at least one part of the electrical conductor connecting the latter to the tag reader can be constituted by a printed circuit on the strip.

Moreover, the second, third and fourth supports are also made of non conductive material, each of said supports, or each of the strips of each of said supports, comprising substantially over the whole of its face opposite to that coming into contact with the objects, animals or persons, a conductive strip connected to a ground of the device.

According to another aspect of the invention, a fabric is proposed for producing a support Implemented in the device according to the invention.

The fabric according to the invention comprises:
a substantially stiff central layer, such as for example substantially stiff plastic,
a smooth layer, on the face coming into contact with the objects, and
a layer composed of a substantially adherent plastic material, for example rubber, on the face opposite to the contact face.

The fabric chosen can be, for example, conveyor belt material. This strip has a smooth face which slides on the slider bed of the conveyor and on the opposite face a substantially adherent material so that the objects remain on the belt when they travel on the conveyor.

The fabric according to the invention can moreover comprise, on the face opposite to the contact face, a conductive layer firmly fixed to the adherent layer and connected to the ground of the device, when the support is a support chosen from the second, third or fourth support. This conductive layer is an adhesive conductive metallic layer carrying out an attenuation of the electromagnetic waves.

This conductive layer is generally of the type of those used in applications for screening electrical appliances that must be EMC (ElectroMagnetic Compatibility) compliant. As a result, the use of this conductive layer for this application is fully justified since it is desired to attenuate and/or prevent the propagation of the electromagnetic waves.

When the fabric is used for the production of the first movable support, its face opposite to the face coming into contact with the objects contains an antenna. More particularly, a layer comprising a printed antenna on one face and on the other an adhesive material is bonded onto the face of the fabric opposite to that coming into contact with the objects.

According to another aspect of the present invention, a system is proposed comprising a device according to the invention, said device comprising at least one first support comprising several strips arranged side by side substantially over the whole width of passage, each of said strips bearing at least one antenna, and a second support, said system comprising moreover:
a reader for the information received by said antennas, and
a multiplexer providing a link between the antennas and the reader.

The system according to the invention can moreover comprise a central processing unit, linked to the reader, for processing the information read by the reader. Advantageously, the system includes a processing assembly comprising the multiplexer, the reader and the central processing unit. Said assembly can be locally allocated to the detection device, i.e. each detection device is associated with a single processing assembly. The processing assembly can be enclosed in a casing mounted on, or in the immediate vicinity of, said detection device.

The system can moreover comprise remote central processing means, suitable for processing information other than that coming from the processing assembly. Thus, the system can comprise several detection devices, as well as one or more devices for sorting the objects, and the central processing means can be suitable for sorting an object, in particular according to the information gathered when the objects pass through the detection device(s).

The system can be a baggage sorting system on check-in or during transit in an airport. It can also be a postal sorting system.

The system according to the invention can in particular be a baggage management system including RFID tags.

According to yet another aspect of the invention a method is proposed using a detection system according to the invention. This method is characterized in that each of the antennas are successively polled, preferably using a multiplexer providing a link between the antennas and the reader. The successive polling is advantageously carried out at such a frequency, depending on the speed of the progress of the object, person or animal crossing said barrier, that any antenna which detects the presence of the object, person or animal is polled at least once during the time over which this presence is detected by this antenna.

According to yet another aspect of the invention, an application of the device according to the invention is proposed, for the identification of objects fitted with tags conveyed on a conveyer.

The objects can be baggage items conveyed in a tunnel at places such as airports, stations or any site accommodating travellers equipped with baggage.

In this case, the tags used can be RFID tags, the frequency band used can be the UHF band. The distance between the first support comprising the antenna and the second and fourth movable supports is comprised between 2.5 to 3 times the wavelength used and the distance between the second and third movable supports is equal to the wavelength used, plus or minus 15%.

Other characteristics and advantages of the invention will also become apparent in the following description.

In the attached drawings, given by way of non-limitative examples:

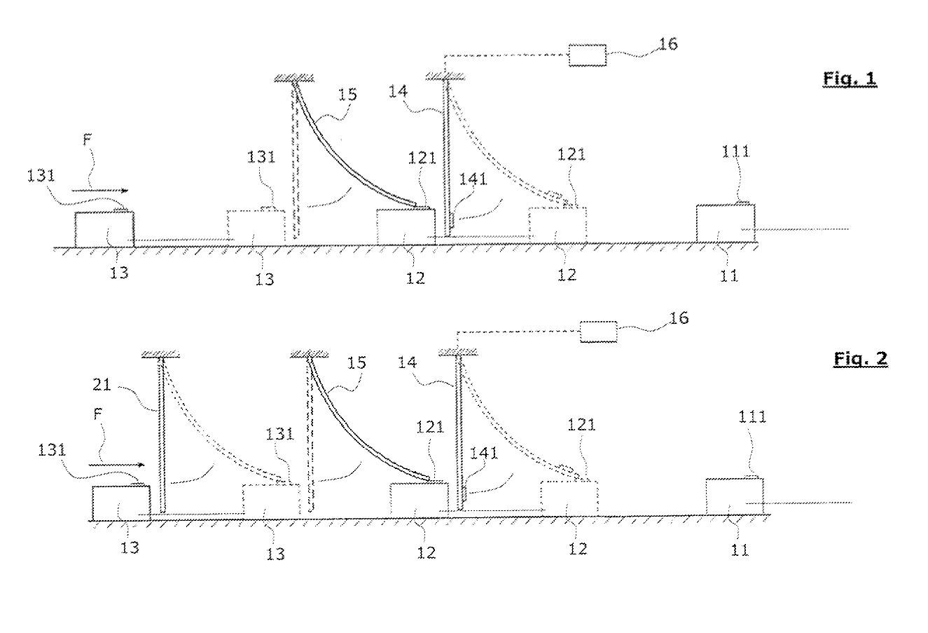

FIG. 1 is a schematic side view of a first example of a device for the detection of the passage of objects, according to the invention, using flexible supports.

FIG. 2 is a view similar to FIG. 1, showing another example of the device according to the invention,

FIG. 3 is a view similar to FIGS. 1 and 2, showing another example of the device according to the invention,

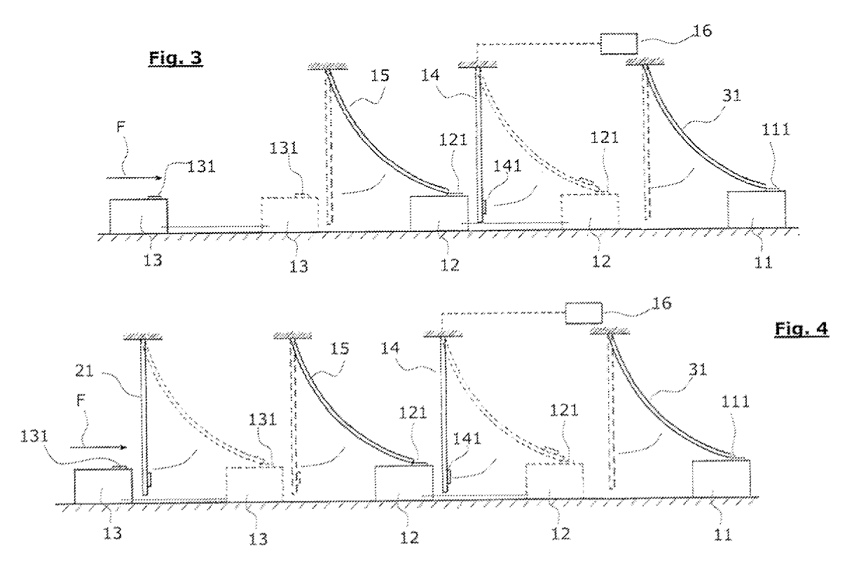

FIG. 4 is a view similar to FIGS. 1-3, showing yet another example of the device according to the invention,

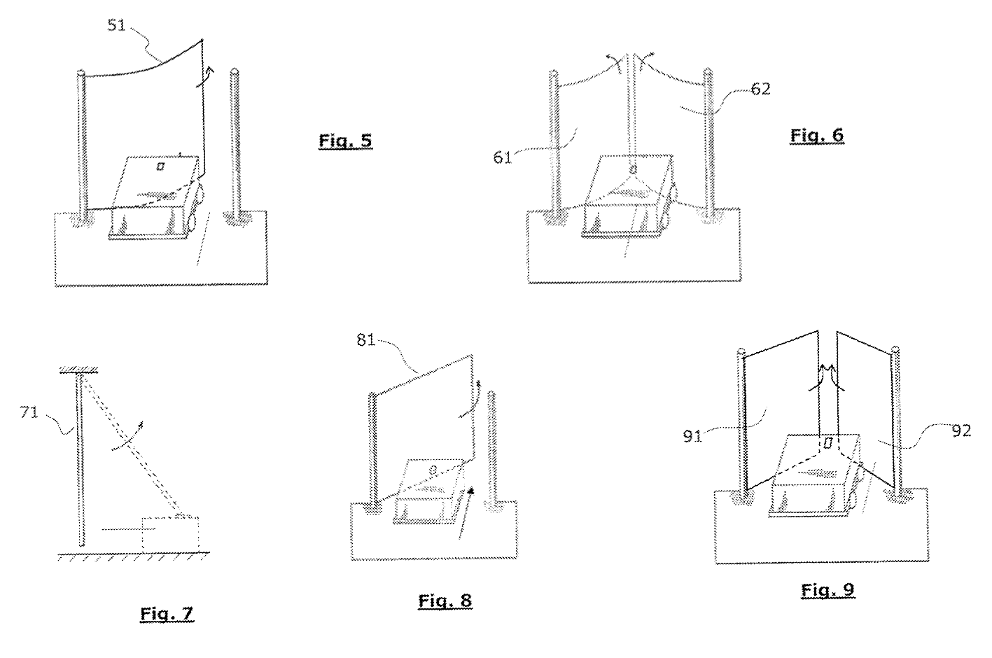

FIGS. 5 and 6 are examples of flexible supports pivoting about a vertical axis capable of implementation in a device according to the invention,

FIG. 7 is an example of a rigid support pivoting about a horizontal axis capable of implementation in a device according to the invention,

FIGS. 8 and 9 are examples of rigid supports pivoting about a vertical axis and capable of implementation in a device according to the invention,

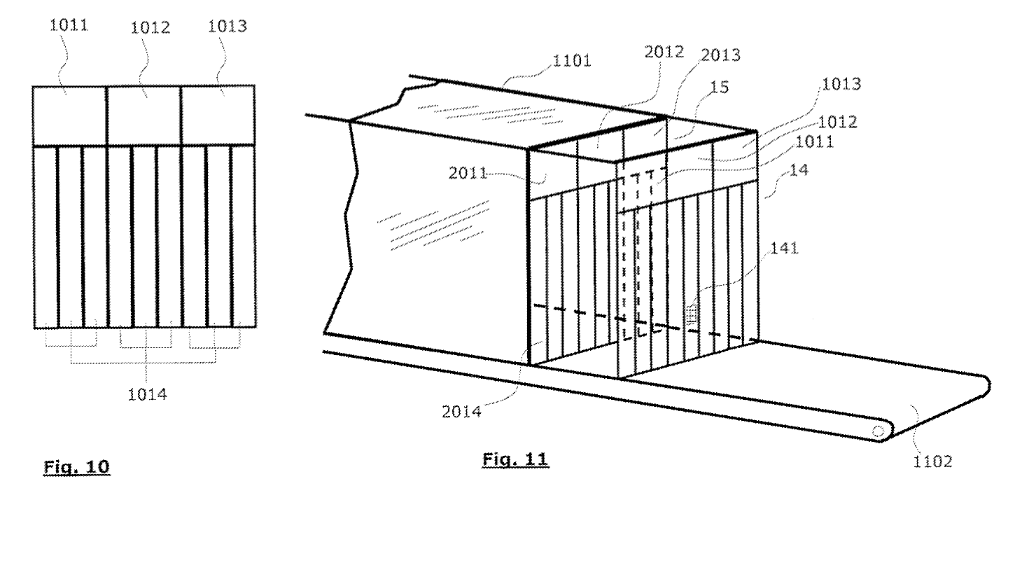

FIG. 10 is a schematic representation of a first flexible support, having a plurality of strips,

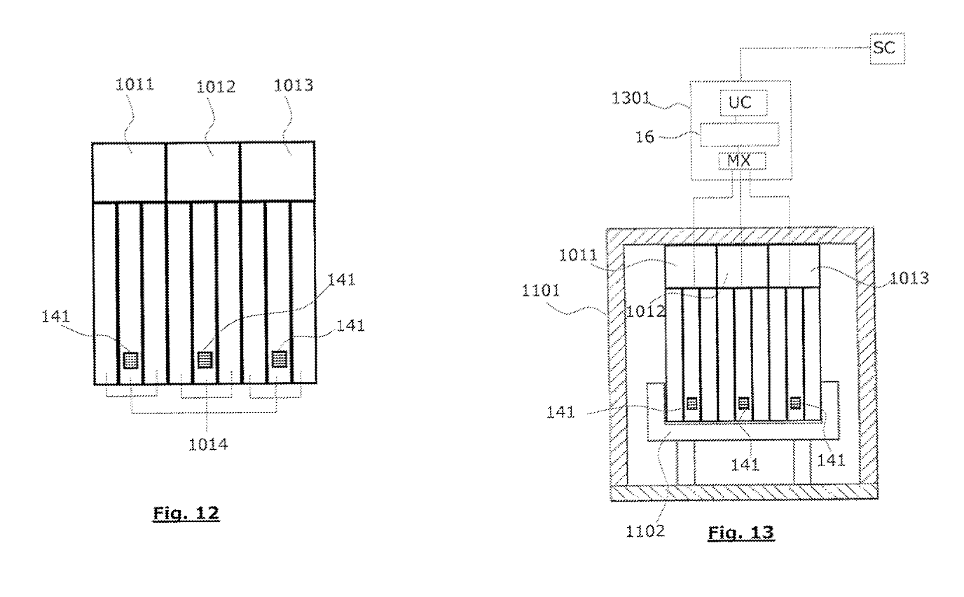

FIG. 11 is a schematic representation of a baggage tunnel equipped with a device according to the invention,

FIG. 12 is a schematic representation of a first support having a plurality of strips each bearing an antenna,

FIG. 13 is a schematic representation of a system according to the invention using a device according to the invention implementing the first support shown in FIG. 12.

In the example described below, the elements common to several figures will keep the same reference.

FIGS. 1 to 4 are examples of devices for the detection of the passing in order of objects 11, 12, 13 each bearing an RFID tag, respectively 111, 121 and 131. The objects 11, 12, 13 follow each other and the direction of passage is indicated by the arrow F. The position of the objects 11, 12, 13 changes over time and they pass from the position where the latter are shown in solid line to a position where they are shown in dotted line.

In the example shown in FIG. 1, the device according to the invention still comprises a first support 14 bearing an antenna 141, for the reading of RFID tags, arranged on the support vertically to the plane of passage of the objects 11, 12 and 13. The device comprises moreover a second support 15 arranged upstream of the first support 14 with respect to the direction in which the objects 11, 12, 13 pass. The device comprises moreover a remote tag reader 16 of the first support 14 linked to the antenna 141 borne by this support.

When the object 12 is in contact with the first support 14, the tag 121 borne by the object 12 is read. At this time the object 13, following the object 12, is located upstream of the second support 15. This second support 15 constitutes a barrier between the object 13 and the antenna 141 attenuating the radio waves and thus preventing the antenna 141 reading the tag 131 borne by the object 13 before the antenna 141 reads the tag 121 of the object 12. Thus, reading the tags 121 and 131 borne respectively by the objects 12 and 13 is carried out in an ordered manner according to the order in which the objects 12 and 13 pass.

In the example of FIG. 2, the device according to the invention comprises, compared to the example shown in FIG. 1, a third support 21 arranged upstream of the second support 15.

In this example, for the tag of the object 12 to be read by the antenna 141, it is necessary for the support 15 located upstream to be raised by the object 12 so that the object is within the zone of sensitivity of the antenna 141, without the following object 13 being itself directly in view of the antenna 141: it must therefore be masked by the curtain 21.

Thus the distance separating the supports 15 and 21 is such that the support can fall back after passage of the object 12 and before the entry of the object 13 into the zone of detection by the antenna 141. For reasons of the desired spacing between the baggage items and the speed of processing the latter, a distance is chosen between nearby curtains that is substantially equal to the wavelength of the antenna, this wavelength defining the zone of sensitivity of the antenna.

In this example, when the object 12 is in contact with the first support 14, the tag 121 borne by the object 12 is read. At this moment the object 13, following the object 12, is located upstream of the second support 15. This second support 15 still constitutes a barrier between the object 13 and the antenna 141 attenuating the radio waves and thus preventing the antenna 141 reading the tag 131 borne by the object 13 before the antenna 141 reads the tag 121 of the object 12. Moreover, the third support 21 constitutes a barrier between the objects following the object 13 and the antenna 141, thus attenuating the passage of the radio waves of the antenna 141 towards the objects which follow the object 13 and thus preventing the antenna 141 reading a tag borne by an object following the object 13 before the tag 121 of the object 12 is read. Thus, the tags are read in an ordered manner with respect to the order in which items pass.

In the example shown in FIG. 3, in addition to the elements in the example shown in FIG. 1, the device according to the invention comprises a fourth support 31 arranged downstream of the first support 14.

When the object 12 is in contact with the first support 14, the tag 121 borne by the object 12 is read. At this time the object 13, following the object 12, is located upstream of the second support 15 and the object 11 located downstream of the object 12 is located downstream of the fourth support 31. In this configuration, the second support 15 constitutes a barrier between the object 13 and the antenna 141, attenuating the radio waves and thus preventing the antenna 141 reading the tag 131 borne by the object 13 before the antenna 141 reads the tag 121 of the object 12. Moreover, the fourth support 31 constitutes a barrier between the object 11 and the antenna 141 attenuating the passage of the radio waves and thus preventing the antenna 141 re-reading the tag 111 borne by the object 11. Thus, reading the tags is carried out in an ordered manner with respect to the order in which items pass and a read tag is not re-read a second time. The antenna 141 and the tag being read are isolated on both sides: on the upstream side by the third support 21 and on the downstream side by the fourth support 31.

The example shown in FIG. 4 is a combination of the examples shown in FIG. 2 and FIG. 3.

The preferred embodiment of the invention is however that represented in FIG. 1, owing to its greater simplicity and the satisfactory results obtained during trials.

The movable supports shown in FIGS. 1-4 are flexible movable supports freely suspended above the passage zone of the objects 11, 12, 13.

FIGS. 5-10 are examples of supports, any combination of which can be used in the device according to the invention and in the examples shown in FIGS. 1-4.

The support 51 shown in FIG. 5 is a flexible support articulated about a vertically-situated axis.

The support shown in FIG. 6 is presented in the form of two elements 61 and 62, each articulated about a vertical axis, located one on each side of the passage zone of the objects.

The supports shown in FIGS. 7-9 are rigid supports.

In FIG. 7, the support 71 shown is articulated rotatably about a horizontal axis situated above the passage zone of the objects.

In FIG. 8, the support 81 is rotated about a vertical axis.

In FIG. 9, the support is presented in the form of two elements 91 and 92, each articulated about a vertical axis located one on each side of the passage zone of the objects.

According to a preferred but non-limitative version, each of the supports is flexible and comprises several strips extending over the whole width of the passage zone and having their lower end close to the base of the passage zone.

The support shown in FIG. 10 is presented in the form of 3 strips 1011, 1012 and 1013 positioned side by side in a plane transverse to the direction in which the objects pass. Each of the strips 1011-1013 comprises several flaps 1014, the lower end of which is close to the base of the passage zone.

When the first support is of this type, then at least one of the flaps 1014 bears an antenna for reading an RFID tag.

In all cases described above, the reader antenna is situated close to the lower end of the first movable support, at a height of the order of 25 cm. The different movable supports 14,15,31 are spaced apart by a distance comprised between 2.5 and 3 times the wavelength of the electromagnetic waves used for the detection, plus or minus 15%.

The device according to the invention can be used for the detection of the passage of objects transported on a conveyor or in a tunnel, such as baggage items in places such as airports.

FIG. 11 is a very schematic representation of a tunnel 1101 in which baggage items (not shown) are conveyed placed on conveyor 1102. At the exit of the tunnel 1101, the device according to the invention comprises a first support 1103 bearing an antenna for reading RFID tags and a second support arranged upstream of the first support just at the exit of the tunnel. The supports are flexible and freely connected to the top of the conveyor 1102, each constituting a separation curtain. The supports used are such as those shown in FIG. 10. The first support is therefore constituted by strips 1011, 1012 and 1013, each comprising several flaps 1014. One of the flaps 1014 of the strip 1012 of the first support 14 bears the antenna 141. The first support is made of conductive material, at least partially implementing the electrical connection of the antenna of 141 to the tag reader.

The second support is also constituted by strips 2011, 2012 and 2013, each comprising several flaps 2014.

In the embodiment shown in FIG. 12, the support comprises several flexible strips 1011, 1012 and 1013 positioned side by side in a plane transverse to the direction in which the objects pass. Each of the strips 1011, 1012, 1013 hears, on its lower part, a reader antenna 141.

A system according to the invention will now be described with reference to FIG. 13, this system including a detection device according to the invention. The device is substantially of the same type as that shown in FIG. 11. However, the first support is that of FIG. 12. It will be noted that the strips 1011, 1012 and 1013 are not joined or overlapping, but have free gaps between them. Nevertheless, these strips 1011, 1012 and 1013 are sufficiently close for an object passing through the device to be detected effectively.

The system shown in FIG. 13 moreover comprises a processing assembly 1301, arranged locally relative to the detection device, and central processing means SC positioned remotely relative to the detection device. The processing assembly 1301 comprises a multiplexer MX, a reader 16 and a central processing unit UC.

Each of the three strips 1011, 1012 and 1013 comprises, at its base, an antenna 141 connected to the multiplexer MX by means of the conductive support. The information received by the antennas 141 and thus multiplexed, is then transmitted to the reader 16 responsible for reading this information. The information is then transmitted to the central processing unit UC to be processed locally. The information can comprise the destination of a baggage item which has just been checked in. Once processed locally, this information can then be transmitted, in full or in part, to the central processing means SC.

The central processing means SC are provided for higher-level processing. For example, the central processing means can be provided to manage equipment for sorting baggage items. They can be provided in particular to activate systems for routing the baggage items and/or to check that baggage items initially checked in by a passenger actually enter and leave the sorting equipment.

A method using such a system with a multiplexer consists of successively polling each of the antennas of the detection device. This scanning is performed at a frequency calculated according to the speed with which the objects to be identified clear the device, so that any antenna detecting an object is polled at least once during the time for which the presence of said object is detected by this antenna. The central processing unit UC is advantageously configured to avoid a double detection, for example if the same antenna detects the same object during two successive pollings, or if two different antennas simultaneously or successively detect the same object.

The central processing means are provided to utilize the data from the system at the level of a central management system. For example, the central processing means can be provided to manage equipment for sorting baggage items. They can be provided in particular to activate systems for routing the baggage items and/or to check that baggage items initially checked in by a passenger actually enter and leave the sorting equipment.

According to a variant, the reader 16 itself can incorporate an antenna reading algorithm detecting the signal with the highest amplitude coming from the multiplexer, which thus denotes the antenna which is best placed at a given time to read the tag(s) situated on the objects to be checked. The information coming from this antenna is then read completely and recorded by the reader in order to be transmitted to the central management system SC. The reader then reads the new signal received that has the highest amplitude and reads the information from the new antenna selected in this way.

If all possible positions of the RFID tags on a baggage item are taken into account, including the above-mentioned least favourable position, the device according to the invention allows recognition of 99.98% of the baggage items passing in front of the antennas of the device according to the invention.

Of course, the invention is not limited to the examples that have just been described and can be used to identify any type of objects, whatever their means of transport.

The invention can also be used to identify persons or animals passing through an access gateway or portal.

Of course, the detection device according to the invention can also comprise one or more antennas borne by fixed parts, which themselves can also be multiplexed with the antennas borne by the movable supports. In particular, the fixed antennas can be positioned below the objects clearing the device, thus improving the detection of any RFID tags positioned under the objects.

1. A device for the detection of the passage of objects, persons or animals bearing a so-called RFID tag, said device comprising: at least one first movable support bearing an antenna electrically connected to a tag reader; and at least one second movable support; each of said movable supports forming, when idle, a barrier with respect to the passage of said objects, persons or animals, and which, on contact with these latter, is movable to a retracted position; said second movable support being arranged upstream of said first movable support with respect to the direction of passage of said objects, persons or animals and being made of a material attenuating the passage of the electromagnetic waves in the direction opposite to that of the passage of the objects, persons or animals.

2. The device according to claim 1, characterized in that it comprises moreover at least one third movable support arranged upstream of the second movable support and attenuating the passage of the electromagnetic waves in the direction opposite to that of the passage of the objects, persons or animals, said at least third movable support forming, when idle, a barrier with respect to the passage of the objects, persons or animals and which, on contact with these latter, is movable to a retracted position.

3. The device according to claim 2, characterized in that it comprises moreover at least one fourth movable support arranged downstream of the first movable support and attenuating the passage of the electromagnetic waves, said at least fourth movable support forming, when idle, a barrier with respect to the passage of the objects, persons or animals and which, on contact with these latter, is movable to a retracted position.

4. The device according to claim 1, characterized in that the different movable supports are spaced apart by a distance equal to the wavelength of the electromagnetic waves used for the detection, plus or minus 15%.

5. The device according to claim 1, characterized in that the different movable supports are spaced apart by a distance comprised between 2.5 to 3 times the wavelength used for the detection.

6. The device according to claim 1, characterized in that at least one of the movable supports is rigid and is articulated about an axis situated above a passage zone.

7. The device according to claim 1, characterized in that at least one of the movable supports is rigid and is articulated about a transverse axis arranged vertically at the side of a passage zone.

8. The device according to claim 1, characterized in that at least one of the movable supports is flexible and is articulated about an axis arranged vertically at the side of a passage zone.

9. The device according to claim 1, characterized in that at least one of the movable supports is made of a flexible material and is suspended freely about a transverse axis situated above a passage zone.

10. The device according to claim 1, characterized in that the antenna is situated close to the lower end of the first movable support so as to be in a passage zone.

11. The device according to claim 1, characterized in that the antenna is situated substantially at a height of 25 cm with respect to a plane of a conveyor on which the objects are located.

12. The device according to claim 1, characterized in that the antenna is situated substantially at the height of a neck of the animals.

13. The device according to claim 1, characterized in that the antenna is situated substantially at the height of a sternum of the persons.

14. The device according to claim 8, characterized in that at least one of the supports comprises one or more flexible strips arranged side by side in a plane transverse to the direction of passage of said objects, persons or animals.

15. The device according to claim 14, characterized in that the first support comprises one or more flexible strips arranged side by side in a plane transverse to the direction of passage of said objects, persons or animals, at least one of said strips bearing the antenna on its lower part.

16. The device according to claim 1, characterized in that the antenna borne by the first support is situated on the opposite face to that coming into contact with the objects.

17. The device according to claim 1, characterized in that the antenna is arranged substantially vertically with respect to the plane of passage of the objects, persons or animals.

18. The device according to claim 15, characterized in that the first support is made of a non-conductive material, on which the antenna is fixed, and its connection circuit to the tag reader, the antenna being arranged on the face of the support opposite to a face in contact with the objects, persons or animals.

19. The device according to claim 3, characterized in that the second, third and fourth supports are made of a non-conductive material, each of said supports comprising substantially over the whole of its face opposite to that coming into contact with the objects, animals or persons, a conductive strip connected to a ground of the device.

20. A fabric for producing a support implemented in the device according to claim 1, comprising:
a substantially stiff central layer;
a layer of which the outer surface is smooth, on the face coming into contact with the objects; and
a layer composed of a substantially adherent plastic material, on the face opposite to the contact face.

21. The fabric according to claim 20, characterized in that it comprises moreover, on the face opposite to the contact face, a conductive layer firmly fixed to the adherent layer, when the support is a support chosen from the second, third or fourth support.

22. A system comprising a device according to claim 1, said device comprising at least one first support comprising several strips arranged side by side substantially over the whole width of passage, each of said strips bearing at least one antenna, and a second support, said system comprising moreover:
a reader for the information received by said antennas, and
a multiplexer providing a link between the antennas and the reader.

23. The system according to claim 22, characterized in that it comprises moreover a central processing unit linked to the reader for processing the information read by the reader.

24. Application of the device according to claim 1, for the identification of objects fitted with tags transported on a conveyor.

25. The application according to claim 24, characterized in that said objects are baggage items conveyed in a tunnel.

26. The application according to claim 24, characterized in that the tags used are RFID tags, the frequency band used is the UHF band and the distance between the first support containing the antenna and the second and fourth movable supports is comprised between 2.5 to 3 times the wavelength used.

27. The application according to claim 24, characterized in that the tags used are RFID tags, the frequency band used is the UHF band and the distance between the second and third movable supports is equal to the wavelength, plus or minus 15%.
